(19) United States
(12) Patent Application Publication
(10) Pub. No.: US 2021/0402382 A1
(43) Pub. Date: Dec. 30, 2021

(54) METAL-DOPED AMORPHOUS CARBON NITRIDE PHOTOCATALYTIC MATERIAL AND PREPARATION METHOD THEREOF

(71) Applicant: SOUTHWEST PETROLEUM UNIVERSITY, Chengdu City, Sichuan (CN)

(72) Inventors: Ying Zhou, Chengdu City, Sichuan (CN); Ruiyang Zhang, Chengdu City, Sichuan (CN); Penghui Li, Chengdu City, Sichuan (CN); Qian Zhang, Chengdu City, Sichuan (CN); Shan Yu, Chengdu City, Sichuan (CN); Fang Wang, Chengdu City, Sichuan (CN)

(21) Appl. No.: 16/481,073

(22) PCT Filed: Dec. 10, 2018
(86) PCT No.: PCT/CN2018/120008

§ 371 Date: Jul. 26, 2019

(30) Foreign Application Priority Data
Jul. 19, 2018 (CN) 201810794271.7

(51) Int. Cl. B01J 31/02; B01J 31/34; B01J 37/04; B01J 37/08; B01J 19/14; B01J 35/00

(52) U.S. Cl. CPC B01J 31/0235; B01J 31/34; B01J 35/004; B01J 37/082; B01J 19/14; B01J 37/04

(57) ABSTRACT

The invention related to photocatalytic material field, and discloses a metal-doped amorphous carbon nitride photocatalytic material and the preparation method thereof. The method comprises: (1) mixing the nitrogen-rich organic matter with the metal salt; (2) calcining the mixture obtained in step (1) to obtain the photocatalytic material; the nitrogen-rich organic matter is selected from one or more of melamine, dicyandiamide, monocyanamide, thiourea, urea, hexamethylenetetramine, and biuret; the metal salt is selected from one or more of an alkali metal salt, an alkaline earth metal salt, and a transition metal salt. The method is simple, efficient, low-cost, requires no external catalyst, organic solvent and protective reagent, and does not require pretreatment of raw materials, and is a preparation method favorable for large-scale commercial production.

### BACKGROUND OF THE INVENTION

### 1. Field of the Invention

The invention relates to the photocatalytic material field, and in particular, to a metal-doped amorphous carbon nitride photocatalytic material and the preparation method thereof.

### 2. Description of the Related Art

Photocatalytic technology can convert clean and renewable solar energy into chemical energy and achieve carbon-zero emission, which not only can effectively purify pollutants, but also alleviate the energy crisis; therefore, photocatalytic technology is considered to be one of the most ideal technologies for future world development. In order to achieve this, the preparation of highly active photocatalytic materials has become an urgent problem to be solved. Graphitic carbon nitride is a graphene-like non-metal photocatalytic material mainly composed of nitrogen atoms and carbon atoms; it is simple in preparation process, adjustable in band structure, and excellent in heat resistance and chemical resistance, which is an ideal photocatalytic material. However, the graphitic carbon nitride has a weak response to visible light and cannot achieve high-efficiency catalysis of visible light. Therefore, the preparation of carbon nitride materials with strong visible light response is the focus of current research. Both theory and experiments have demonstrated that amorphous semiconductor materials generally have a narrow band gap due to the presence of a tail, which can broaden the absorption of visible light and achieve high-efficiency catalysis of visible light. However, the amorphous material lacks a long-range ordered structure, which results in a high recombination rate of photoelectron-hole pairs and poor photocatalytic performance.

Recently, monoatomic catalytic materials have received extensive attention because monoatomic catalytic materials can maximize the active sites of metal atoms and provide channels for electrons to pass between photocatalytic materials and metal atoms. It is worth mentioning that the strong interaction force between the single atom and the carrier can cause the change of the structure of the carrier or even the transformation of the phase. Thus, if a single atom is embedded inside the structure of the graphitic carbon nitride material, it may cause a transition of the graphitic carbon nitride material from a crystalline state to an amorphous state, then such amorphous carbon nitride can achieve efficient visible light absorption, while strong interaction between single atom and carbon nitride materials provides new carrier channels for efficient electron-hole pair separation. However, there are still no relevant reports.

### SUMMARY OF THE INVENTION

The object of the invention is to overcome the problem of low catalytic efficiency of visible light in the prior art, and to provide a metal-doped amorphous carbon nitride photocatalytic material and the preparation method thereof; the method is based on solid-phase high temperature pyrolysis method, and a photocatalytic material with excellent visible light photocatalytic activity is synthesized by inducing a carbon nitride amorphous transition by a single atom metal. In addition, the method is simple, efficient, low-cost, requires no external catalyst, organic solvent and protective reagent, and does not require pretreatment of raw materials, and is a preparation method favorable for large-scale commercial production.

A preparation method of metal-doped amorphous carbon nitride photocatalytic material, wherein the preparation method comprises:

(1) mixing the nitrogen-rich organic matter with the metal salt;

(2) calcining the mixture obtained in step (1) to obtain the photocatalytic material;

the nitrogen-rich organic matter is selected from one or more of melamine, dicyandiamide, monocyanamide, thiourea, urea, hexamethylenetetramine, and biuret; the metal salt is selected from one or more of an alkali metal salt, an alkaline earth metal salt, and a transition metal salt.

The second aspect of the invention provides a metal-doped amorphous carbon nitride photocatalytic material prepared by the above preparation method.

Through the above technical solutions, the invention is based on solid-phase high temperature pyrolysis method; a single atom is embedded inside the structure of the graphitic carbon nitride material, which causes a transition of the graphitic carbon nitride material from a crystalline state to an amorphous state. On the one hand, amorphous carbon nitride can achieve efficient visible light absorption, and on the other hand, the strong interaction between single atom and carbon nitride materials provides new carrier channels for efficient electron-hole pair separation; therefore, a photocatalytic material with excellent visible light photocatalytic activity is synthesized. In addition, the method is simple, efficient, low-cost, requires no external catalyst, organic solvent and protective reagent, and does not require pretreatment of raw materials, and is a preparation method favorable for large-scale commercial production.

### BRIEF DESCRIPTION OF THE DRAWINGS

The drawings constituting a part of the disclosure provide a further understanding of the invention, the exemplary embodiments and the description of the invention are used to explain the disclosure, and not intended to limit the invention. In the drawings:

FIG. 1 is a physical diagram illustrating the photocatalytic material and the ordinary graphitic carbon nitride material prepared in Embodiment 1 of the invention;

FIG. 2 is an X-ray diffraction pattern illustrating the photocatalytic material prepared in Embodiment 1 of the invention;

FIG. 3 is a Fourier transform infrared spectrum illustrating the photocatalytic material prepared in Embodiment 1 of the invention;

FIG. 4 is an atomic force microscope diagram illustrating the photocatalytic material prepared in Embodiment 1 of the invention;

FIG. 5 is a high resolution transmission electron micrograph illustrating the photocatalytic material prepared in Embodiment 1 of the invention;

FIG. 6 is an ultraviolet-visible absorption spectrum illustrating the photocatalytic material prepared in Embodiment 1 of the invention;

FIG. 7 is a fluorescence spectrum illustrating the photocatalytic material prepared in Embodiment 1 of the invention;

FIG. 8 is a diagram illustrating the reduction of CO₂ activity under visible light of the photocatalytic material prepared in Embodiment 1 of the invention.

### REFERENCE NUMERALS OF THE DRAWINGS

1 refers to the ordinary graphitic carbon nitride material.
2 refers to the photocatalytic material prepared in Embodiment 1 of the invention.

### DETAILED DESCRIPTION OF THE PREFERRED EMBODIMENTS

The specific embodiments of the invention is described in detail with reference to the drawings hereinafter. It shall to be understood that the specific embodiments described herein are merely illustrative and not restrictive of the invention.

The first aspect of the invention provides a preparation method of metal-doped amorphous carbon nitride photocatalytic material, wherein the preparation method comprises:

(1) mixing the nitrogen-rich organic matter with the metal salt;

(2) calcining the mixture obtained in step (1) to obtain the photocatalytic material;

the nitrogen-rich organic matter is selected from one or more of melamine, dicyandiamide, monocyanamide, thiourea, urea, hexamethylenetetramine, and biuret; the metal salt is selected from one or more of an alkali metal salt, an alkaline earth metal salt, and a transition metal salt.

According to the invention, preferably, the nitrogen-rich organic matter is one or more of melamine, dicyandiamide, and urea, more preferably, the nitrogen-rich organic matter is melamine and/or urea.

In the invention, when the nitrogen-rich organic matter is any two of melamine, dicyandiamide, monocyanamide, thiourea, urea, hexamethylenetetramine, and biuret, for example, when the nitrogen-rich organic matter is the mixture of melamine and dicyandiamide; when the nitrogen-rich organic matter is the mixture of melamine and monocyanamide; when the nitrogen-rich organic matter is the mixture of melamine and thiourea; when the nitrogen-rich organic matter is the mixture of melamine and urea; when the nitrogen-rich organic matter is the mixture of melamine and hexamethylenetetramine; when the nitrogen-rich organic matter is the mixture of melamine and biuret; when the nitrogen-rich organic matter is the mixture of dicyandiamide and monocyanamide; when the nitrogen-rich organic matter is the mixture of dicyandiamide and thiourea; when the nitrogen-rich organic matter is the mixture of dicyandiamide and urea; when the nitrogen-rich organic matter is the mixture of dicyandiamide and hexamethylenetetramine; when the nitrogen-rich organic matter is the mixture of dicyandiamide and biuret; when the nitrogen-rich organic matter is the mixture of monocyanamide and thiourea; when the nitrogen-rich organic matter is the mixture of monocyanamide and urea; when the nitrogen-rich organic matter is the mixture of monocyanamide and hexamethylenetetramine; when the nitrogen-rich organic matter is the mixture of monocyanamide and biuret; when the nitrogen-rich organic matter is the mixture of thiourea and urea; when the nitrogen-rich organic matter is the mixture of thiourea and hexamethylenetetramine; when the nitrogen-rich organic matter is the mixture of thiourea and biuret; when the nitrogen-rich organic matter is the mixture of hexamethylenetetramine and biuret, the weight ratio of any two components can be 1:(0.1-20).

In the invention, when the nitrogen-rich organic matter is preferably or more preferably the above specific matter, the monoatomic metal can be more easily doped, and the effect is better.

According to the invention, the metal salt is selected from one or more of ammonium molybdate, sodium tungstate, nickel acetate, potassium nitrate, zinc acetate, copper sulfate, cobalt nitrate, sodium vanadate, and ferrous sulfate, preferably one or more of ammonium molybdate, sodium tungstate, zinc acetate, copper sulfate and nickel acetate, and more preferably ammonium molybdate and/or zinc acetate.

In the invention, when the meal salt is any two of ammonium molybdate, sodium tungstate, nickel acetate, potassium nitrate, zinc acetate, copper sulfate, cobalt nitrate, sodium vanadate, and ferrous sulfate, for example, when the metal salt is the mixture of ammonium molybdate and sodium tungstate; when the metal salt is the mixture of ammonium molybdate and nickel acetate; when the metal salt is the mixture of ammonium molybdate and potassium nitrate; when the metal salt is the mixture of ammonium molybdate and zinc acetate; when the metal salt is the mixture of ammonium molybdate and copper sulfate; when the metal salt is the mixture of ammonium molybdate and cobalt nitrate; when the metal salt is the mixture of ammonium molybdate and sodium vanadate; when the metal salt is the mixture of ammonium molybdate and ferrous sulfate; when the metal salt is the mixture of sodium tungstate and nickel acetate; when the metal salt is the mixture of sodium tungstate and potassium nitrate; when the metal salt is the mixture of sodium tungstate and zinc acetate; when the metal salt is the mixture of sodium tungstate and copper sulfate; when the metal salt is the mixture of sodium tungstate and cobalt nitrate; when the metal salt is the mixture of sodium tungstate and sodium vanadate; when the metal salt is the mixture of sodium tungstate and ferrous sulfate; when the metal salt is the mixture of nickel acetate and potassium nitrate; when the metal salt is the mixture of nickel acetate and zinc acetate; when the metal salt is the mixture of nickel acetate and copper sulfate; when the metal salt is the mixture of nickel acetate and cobalt nitrate; when the metal salt is the mixture of nickel acetate and sodium vanadate; when the metal salt is the mixture of nickel acetate and ferrous sulfate; when the metal salt is the mixture of potassium nitrate and zinc acetate; when the metal salt is the mixture of potassium nitrate and copper sulfate; when the metal salt is the mixture of potassium nitrate and cobalt nitrate; when the metal salt is the mixture of potassium nitrate and zinc acetate sodium vanadate; when the metal salt is the mixture of potassium nitrate and ferrous sulfate; when the metal salt is the mixture of zinc acetate and copper sulfate; when the metal salt is the mixture of zinc acetate and cobalt nitrate; when the metal salt is the mixture of zinc acetate and sodium vanadate; when the metal salt is the mixture of zinc acetate and ferrous sulfate; when the metal salt is the mixture of copper sulfate and cobalt nitrate; when the metal salt is the mixture of copper sulfate and sodium vanadate; when the metal salt is the mixture of copper sulfate and ferrous sulfate; when the metal salt is the mixture of cobalt nitrate and sodium vanadate; when the metal salt is the mixture of cobalt nitrate and ferrous sulfate; when the metal salt is the mixture of sodium vanadate and ferrous sulfate, the weight ratio of any two components can be 1:(0.1-20).

According to the invention, in step (1), the mass ratio of the nitrogen-rich organic matter to the metal salt is 100:(1-50), preferably 100:(1-20), and more preferably 100:(3.2-10.4).

According to the invention, in step (2), the conditions of calcination comprise: holding at a temperature of 400-700° C. for 1-20 hours, and the heating rate thereof is 1-50° C./min; preferably, holding at a temperature of 500-600° C. for 4-10 hours, and the heating rate thereof is 3-20° C./min. In addition, in the invention, it is necessary to note that the heating rate is started from room temperature until the temperature is raised to a required temperature.

According to the invention, in step (2), the calcination is carried out under the protection of an optional inert gas, and the inert gas is argon, nitrogen or helium; in the invention, “an optional inert gas” means that there may be an inert gas or no inert gas; preferably, the calcination is carried out under the protection of inert gas.

The second aspect of the invention provides a metal-doped amorphous carbon nitride photocatalytic material prepared by the above method.

According to the invention, the photocatalytic material is a black or grayish powder, and the main components are metal, carbon, nitrogen and oxygen. In the invention, “grayish” means close to gray or gray, and the photocatalytic material is amorphous. In addition, in the invention, the photocatalytic material contains a metal-doped amorphous carbon nitride structure; the metal is one or more of an alkali metal, an alkaline earth metal, and a transition metal; preferably, the metal is one or more of molybdenum, tungsten, nickel, potassium, zinc, copper, cobalt, vanadium and iron; more preferably, the metal is one or more of molybdenum, tungsten, nickel, zinc and copper; most preferably, the metal is molybdenum and/or zinc;

Preferably, the photocatalytic material does not exhibit a diffraction peak at 10°-70° in the X-ray diffraction pattern.

In the invention, it should be noted that the transition of the carbon nitride material from a crystalline state to an amorphous state may be related to the metal atom type, the metal atom size, and the bonding between nitrogen and carbon atoms, which has little relationship with the amount of doped metal. Previous experiments have shown that no matter how much metal is doped, it is possible to cause amorphization of carbon nitride; preferably, based on the total weight of the metal-doped amorphous carbon nitride photocatalytic material, when the doping amount of the metal is at least 0.5% by weight, the transition of the carbon nitride material from a crystalline state to an amorphous state is more perfect.

According to the invention, the photocatalytic material has photocatalytic activity in the visible region of 450-800 nm. That is, the photocatalytic material responds in a full range or in a partial range in the visible region of 450-800 nm.

The invention is described in detail with the embodiments hereinafter.

(1) In the Embodiments and Comparative Embodiments hereinafter, melamine is purchased from aladdin; ammonium molybdate, dicyandiamide, monocyanamide, thiourea and boric acid are purchased from Chengdu Kelon Chemical Reagent Factory; urea is purchased from Tianjin Kermel Chemical Reagent Co., Ltd.; other reagents are purchased from Chengdu Kelon Chemical Reagent Factory.

(2) In the Embodiments and Comparative Embodiments hereinafter, X-ray diffraction analysis is performed on an X-ray diffractometer, model PANalytical X′Pert PRO, purchased from PANalytical, The Netherlands;

Fourier transform infrared spectrum analysis is performed on a Fourier transform infrared spectrometer, model Nicolet 6700, purchased from Thermo Scientific, USA;

Sample surface analysis is performed on an atomic force microscope, model Dimension Icon, purchased from Bruker, USA;

Spherical electron microscope analysis is performed on a high-resolution transmission electron microscope, model ARM200CF, purchased from JEOL Corporation, Japan;

Ultraviolet-visible absorption spectrum is performed on an ultraviolet-visible absorption spectrometer, model Shimadzu UV-2600, purchased from Shimadzu Corporation, Japan;

Fluorescence spectrum is performed on a fluorescence spectrometer, model F-7000, purchased from HITACHI, Japan;

The reduction of CO₂ activity under visible light of the sample id performed on a gas chromatograph, model CG7900, purchased from Beijing Techcomp Co., Ltd.;

The tube furnace is produced by Hefei Risine High Temperature Technology Co., Ltd., model CVD(D)-06/60/3.

### Embodiment 1

(1) Mixing melamine with ammonium molybdate in a ratio of 100:5.5;

(2) heating the above mixture in a tube furnace at 10° C./min to 550° C., holding the temperature for 4 hours to be cooled to room temperature to obtain the molybdenum-doped amorphous carbon nitride photocatalytic material, marking it as S1, and its performance is tested as shown in Table 1.

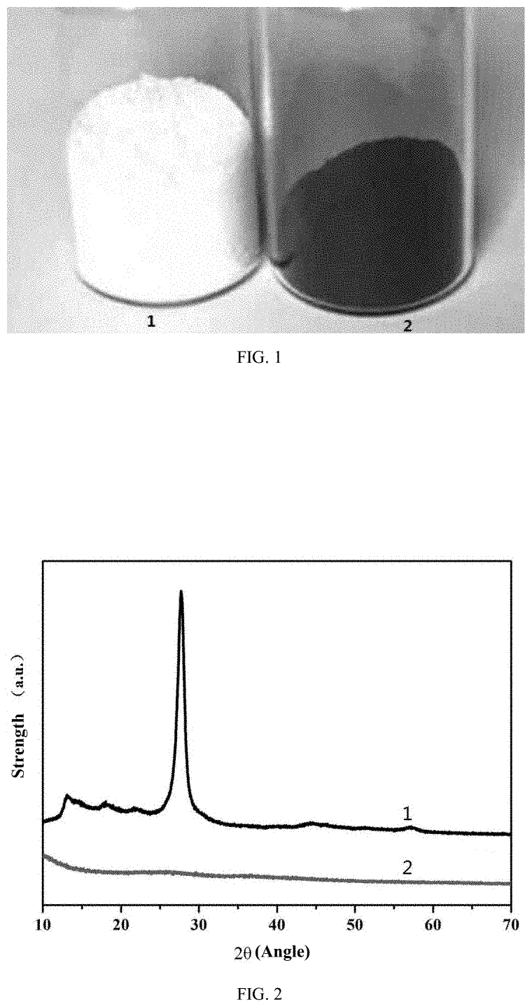

FIG. 1 is a physical diagram illustrating the photocatalytic material and the ordinary graphitic carbon nitride material prepared in Embodiment 1 of the invention; “1” refers to the ordinary graphitic carbon nitride material, and “2” refers to the photocatalytic material S1 prepared in Embodiment 1 of the invention; as can be seen from the figure, the ordinary graphitic carbon nitride material is pale yellow, and the photocatalytic material S1 prepared in Embodiment 1 of the invention is black.

FIG. 2 is an X-ray diffraction pattern illustrating the photocatalytic material prepared in Embodiment 1 of the invention; as can be seen from the figure, the ordinary graphitic carbon nitride material exhibits two diffraction peaks at 13.1° and 27.4°, representing the (100) and (002) crystal planes of the graphitic carbon nitride material; the photocatalytic material S1 prepared in Embodiment 1 of the invention exhibits no significant diffraction peak, and it is proved that the photocatalytic material S1 prepared in Embodiment 1 of the invention is amorphous.

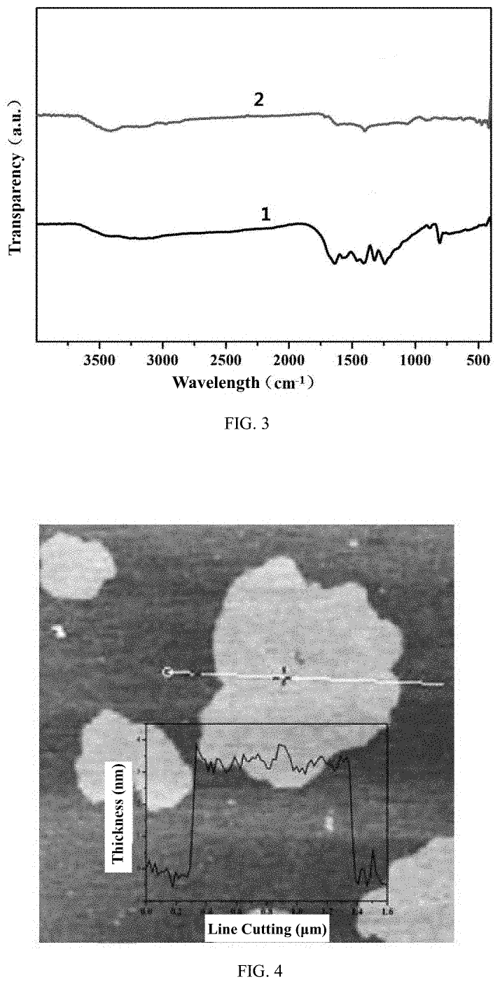

FIG. 3 is a Fourier transform infrared spectrum illustrating the photocatalytic material prepared in Embodiment 1 of the invention; as can be seen from the figure, the peak of the photocatalytic material S1 prepared in Embodiment 1 of the invention is weakened, and it is proved that the photocatalytic material S1 prepared in Embodiment 1 of the invention is amorphous.

FIG. 4 is an atomic force microscope diagram illustrating the photocatalytic material prepared in Embodiment 1 of the invention; as can be seen from the figure, the photocatalytic material S1 prepared in Embodiment 1 of the invention is smooth in surface, and it is proved that the high dispersion of the monoatomic metal induces the amorphous formation of carbon nitride.

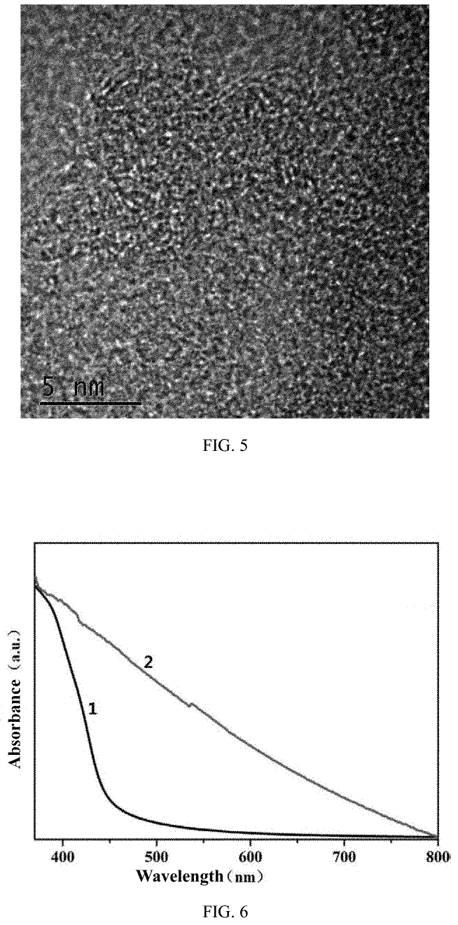

FIG. 5 is a high resolution transmission electron micrograph illustrating the photocatalytic material prepared in Embodiment 1 of the invention; as can be seen from the figure, the photocatalytic material S1 prepared in Embodiment 1 of the invention is free of lattice fringes, and it is proved that the photocatalytic material S1 prepared in Embodiment 1 of the invention is amorphous.

FIG. 6 is an ultraviolet-visible absorption spectrum illustrating the photocatalytic material prepared in Embodiment 1 of the invention; as can be seen from the figure, the photocatalytic material S1 prepared in Embodiment 1 of the invention has absorbing ability in the entire visible light region, and it is proved that the photocatalytic material S1 prepared in Embodiment 1 of the invention has excellent absorbing ability of visible light.

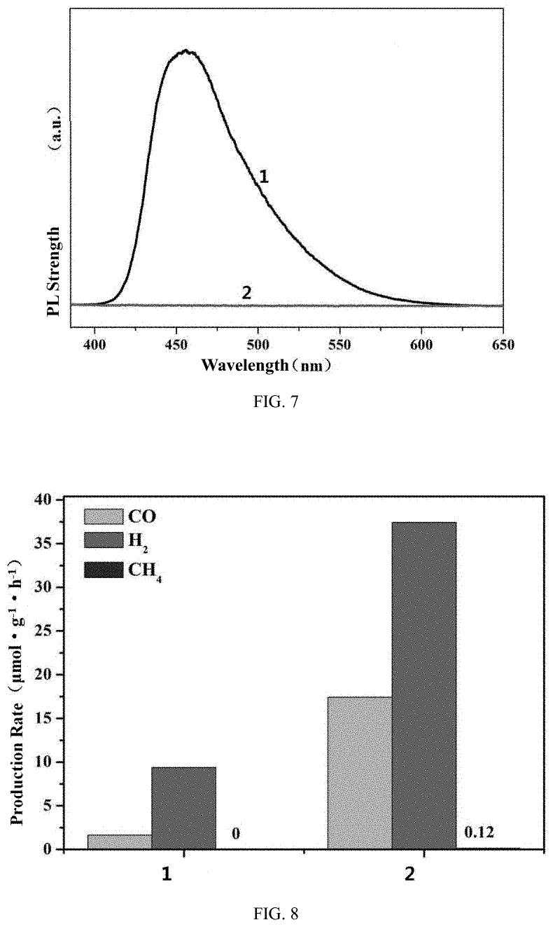

FIG. 7 is a fluorescence spectrum illustrating the photocatalytic material prepared in Embodiment 1 of the invention; as can be seen from the figure, the photocatalytic material S1 prepared in Embodiment 1 of the invention has almost no fluorescence generation, and it is proved that the photocatalytic material S1 prepared in Embodiment 1 of the invention is rapidly separated by photoelectron-hole pairs.

FIG. 8 is a diagram illustrating the reduction of CO₂ activity under visible light of the photocatalytic material prepared in Embodiment 1 of the invention; “1” refers to the ordinary graphitic carbon nitride material, and “2” refers to the photocatalytic material S1 prepared in Embodiment 1 of the invention; as can be seen from the figure, in the production rate of the ordinary graphitic carbon nitride material, the value of CO is 1.67 mol g⁻¹ h⁻¹, the value of H₂ is 9.33 mol g⁻¹ h⁻¹, and the value of CH₄ is 0 mol g⁻¹ h⁻¹; in the production rate of the photocatalytic material S1 prepared in Embodiment 1 of the invention, the value of CO is 17.5 mol g⁻¹ h⁻¹, the value of H₂ is 37.33 mol g⁻¹ h⁻¹, and the value of CH₄ is 0.12 μmol g⁻¹ h⁻¹, which means that the production rate of the photocatalytic material S1 prepared in Embodiment 1 of the invention has excellent performance in reduction of CO₂ activity under visible light, and it is proved that the production rate of the photocatalytic material S1 prepared in Embodiment 1 of the invention has high photocatalytic activity of visible light. In addition, in FIG. 8, it should be noted that the abscissa has no specific parameters, and it is only used to represent the ordinary graphitic carbon nitride material, and the CO, H₂ and CH₄ in the photocatalytic material S1 prepared in Embodiment 1 of the invention.

### Embodiment 2

(1) Mixing melamine with ammonium molybdate in a ratio of 100:10.4;

(2) heating the above mixture in a tube furnace at 10° C./min to 550° C., holding the temperature for 4 hours to be cooled to room temperature to obtain the molybdenum-doped amorphous carbon nitride photocatalytic material, marking it as S2, and its performance is tested as shown in Table 1.

### Embodiment 3

(1) Mixing melamine with ammonium molybdate in a ratio of 100:7.9;

(2) heating the above mixture in a tube furnace at 10° C./min to 550° C., holding the temperature for 4 hours to be cooled to room temperature to obtain the molybdenum-doped amorphous carbon nitride photocatalytic material, marking it as S3 and its performance is tested as shown in Table 1.

### Embodiment 4

(1) Mixing melamine with ammonium molybdate in a ratio of 100:3.2

(2) heating the above mixture in a tube furnace at 10° C./min to 550° C., holding the temperature for 4 hours to be cooled to room temperature to obtain the molybdenum-doped amorphous carbon nitride photocatalytic material, marking it as S4 and its performance is tested as shown in Table 1.

### Embodiment 5

Preparing the photocatalytic material in the same way as in Embodiment 1, except that the melamine is replaced with dicyandiamide.

The molybdenum-doped amorphous carbon nitride photocatalytic material is obtained, marking it as S5 and its performance is tested as shown in Table 1.

### Embodiment 6

Preparing the photocatalytic material in the same way as in Embodiment 1, except that the melamine is replaced with monocyanamide.

The molybdenum-doped amorphous carbon nitride photocatalytic material is obtained, marking it as S6 and its performance is tested as shown in Table 1.

### Embodiment 7

Preparing the photocatalytic material in the same way as in Embodiment 1, except that the melamine is replaced with thiourea.

The molybdenum-doped amorphous carbon nitride photocatalytic material is obtained, marking it as S7 and its performance is tested as shown in Table 1.

### Embodiment 8

Preparing the photocatalytic material in the same way as in Embodiment 1, except that the melamine is replaced with urea.

The molybdenum-doped amorphous carbon nitride photocatalytic material is obtained, marking it as S8 and its performance is tested as shown in Table 1.

### Embodiment 9

Preparing the photocatalytic material in the same way as in Embodiment 1, except that the melamine is mixed with ammonium molybdate in a ratio of 100:20.

The molybdenum-doped amorphous carbon nitride photocatalytic material is obtained, marking it as S9 and its performance is tested as shown in Table 1.

### Embodiment 10

Preparing the photocatalytic material in the same way as in Embodiment 1, except that the above mixture is heated in a tube furnace at 5° C./min to 600° C., and the temperature is held for 3 hours to be cooled to room temperature.

The molybdenum-doped amorphous carbon nitride photocatalytic material is obtained, marking it as S10 and its performance is tested as shown in Table 1.

### Embodiment 11

Preparing the photocatalytic material in the same way as in Embodiment 1, except that the melamine is replaced with the mixture of melamine and dicyandiamide, and the weight ratio of melamine and dicyandiamide is 1:1.

The molybdenum-doped amorphous carbon nitride photocatalytic material is obtained, marking it as S11 and its performance is tested as shown in Table 1.

### Embodiment 12

Preparing the photocatalytic material in the same way as in Embodiment 1, except that the ammonium molybdate is replaced with the mixture of ammonium molybdate and sodium tungstate, and the weight ratio of ammonium molybdate and sodium tungstate is 1:1.

The molybdenum-and-tungsten-doped amorphous carbon nitride photocatalytic material is obtained, marking it as S12 and its performance is tested as shown in Table 1.

### Embodiment 13

Preparing the photocatalytic material in the same way as in Embodiment 1, except that the melamine is replaced with hexamethylenetetramine.

The molybdenum-doped amorphous carbon nitride photocatalytic material is obtained, marking it as S13 and its performance is tested as shown in Table 1.

### Embodiment 14

Preparing the photocatalytic material in the same way as in Embodiment 1, except that the melamine is replaced with biuret. The molybdenum-doped amorphous carbon nitride photocatalytic material is obtained, marking it as S14 and its performance is tested as shown in Table 1.

### Embodiment 15

Preparing the photocatalytic material in the same way as in Embodiment 1, except that the ammonium molybdate is replaced with sodium tungstate. The tungstate-doped amorphous carbon nitride photocatalytic material is obtained, marking it as S15 and its performance is tested as shown in Table 1.

### Embodiment 16

Preparing the photocatalytic material in the same way as in Embodiment 1, except that the ammonium molybdate is replaced with nickel acetate.

The nickel-doped amorphous carbon nitride photocatalytic material is obtained, marking it as S16 and its performance is tested as shown in Table 1.

### Embodiment 17

Preparing the photocatalytic material in the same way as in Embodiment 1, except that the ammonium molybdate is replaced with potassium nitrate.

The potassium-doped amorphous carbon nitride photocatalytic material is obtained, marking it as S17 and its performance is tested as shown in Table 1.

### Embodiment 18

Preparing the photocatalytic material in the same way as in Embodiment 1, except that the ammonium molybdate is replaced with zinc acetate.

The zinc-doped amorphous carbon nitride photocatalytic material is obtained, marking it as S18 and its performance is tested as shown in Table 1.

### Embodiment 19

Preparing the photocatalytic material in the same way as in Embodiment 1, except that the ammonium molybdate is replaced with copper sulfate.

The copper-doped amorphous carbon nitride photocatalytic material is obtained, marking it as S19 and its performance is tested as shown in Table 1.

### Embodiment 20

Preparing the photocatalytic material in the same way as in Embodiment 1, except that the ammonium molybdate is replaced with cobalt nitrate.

The cobalt-doped amorphous carbon nitride photocatalytic material is obtained, marking it as S20 and its performance is tested as shown in Table 1.

### Embodiment 21

Preparing the photocatalytic material in the same way as in Embodiment 1, except that the ammonium molybdate is replaced with sodium vanadate. The vanadate-doped amorphous carbon nitride photocatalytic material is obtained, marking it as S21 and its performance is tested as shown in Table 1.

### Embodiment 22

Preparing the photocatalytic material in the same way as in Embodiment 1, except that the ammonium molybdate is replaced with ferrous sulfate. The ferrous-doped amorphous carbon nitride photocatalytic material is obtained, marking it as S22 and its performance is tested as shown in Table 1.

### Comparative Embodiment 1

Preparing the photocatalytic material in the same way as in Embodiment 1, except that the melamine is replaced with graphitic carbon nitride, wherein the graphitic carbon nitride is prepared by pyrolyzing melamine, that is, the graphitic carbon nitride is not a nitrogen-rich organic matter as defined in the invention. The photocatalytic material obtained is marked as D1 and its performance is tested as shown in Table 1.

### Comparative Embodiment 2

Preparing the photocatalytic material in the same way as in Embodiment 1, except that the ammonium molybdate is replaced with boric acid. The photocatalytic material obtained is marked as D2 and its performance is tested as shown in Table 1.

### Comparative Embodiment 3

Preparing the photocatalytic material in the same way as in Embodiment 1, except that the melamine is mixed with ammonium molybdate in a ratio of 100:0.1. The photocatalytic material obtained is marked as D3 and its performance is tested as shown in Table 1.

### Comparative Embodiment 4

Preparing the photocatalytic material in the same way as in Embodiment 1, except that the above mixture is heated in a tube furnace at 10° C./min to 800° C., and the temperature is held for 1 hour to be cooled to room temperature.

The photocatalytic material obtained is marked as D4 and its performance is tested as shown in Table 1.

TABLE 1

| | | Response Range in the Visible |
|---|---|---|
| | Color | Region of 450-800 nm |
| S1 | Black | 450-775 |
| S2 | Black | 450-800 |
| S3 | Black | 450-750 |
| S4 | Black | 450-725 |
| S5 | Black | 450-600 |
| S6 | Black | 450-600 |
| S7 | Black | 450-500 |
| S8 | Black | 450-500 |
| S9 | Black | 450-600 |
| S10 | Black | 450-600 |
| S11 | Black | 450-600 |
| S12 | Black | 450-600 |
| S13 | Black | 450-700 |
| S14 | Black | 450-700 |
| S15 | Black | 460-650 |
| S16 | Black | 450-700 |
| S17 | Black | 450-580 |
| S18 | Black | 450-500 |
| S19 | Black | 450-580 |
| S20 | Black | 450-650 |
| S21 | Black | 450-600 |
| S22 | Black | 450-620 |
| D1 | Pale Yellow | Null |
| D2 | Pale Yellow | Null |
| D3 | Pale Yellow | Null |
| D4 | White | Null |

It can be seen from Embodiments 1-22 and Comparative Embodiments 1-4 that in Embodiments 1-22, the preparation methods of the invention are adopted; the invention is based on solid-phase high temperature pyrolysis method; a single atom is embedded inside the structure of the graphitic carbon nitride material, which causes a transition of the graphitic carbon nitride material from a crystalline state to an amorphous state. On the one hand, amorphous carbon nitride can achieve efficient visible light absorption, and on the other hand, the strong interaction between single atom and carbon nitride materials provides new carrier channels for efficient electron-hole pair separation; therefore, a photocatalytic material with excellent visible light photocatalytic activity is synthesized. In addition, the method is simple, efficient, low-cost, requires no external catalyst, organic solvent and protective reagent, and does not require pretreatment of raw materials, and is a preparation method favorable for large-scale commercial production.

In addition, it can be seen from the data in Table 1 that: the photocatalytic materials prepared in Embodiments 1-22 have excellent photocatalytic activity in the visible region of 450-800 nm; while in Comparative Embodiments 1-4, the technical solutions of the invention are not adopted, so the photocatalytic materials prepared therein do not have photocatalytic activity in the visible region of 450-800 nm; further, it can be seen that the photocatalytic materials in Comparative Embodiments 1-4 have relatively low photocatalytic activity in the visible region of 450-800 nm with respect to Embodiments 1-22.

The preferred embodiments of the invention have been described in detail above with reference to the drawings, but the invention is not limited thereto. Various modifications may be made to the technical solutions of the invention within the scope of the technical conceptions of the invention, including the combination of specific technical features in any suitable manner. In order to avoid unnecessary repetition, various possible combinations of the invention will not be further described. However, these simple variations and combinations are considered to be the disclosure of the invention, and shall all fall within the protection scope of the invention.

1. A preparation method of metal-doped amorphous carbon nitride photocatalytic material, wherein the preparation method comprises:
(1) mixing the nitrogen-rich organic matter with the metal salt;
(2) calcining the mixture obtained in step (1) to obtain the photocatalytic material;
the nitrogen-rich organic matter is selected from one or more of melamine, dicyandiamide, monocyanamide, thiourea, urea, hexamethylenetetramine, and biuret; the metal salt is selected from one or more of an alkali metal salt, an alkaline earth metal salt, and a transition metal salt.

2. The method according to claim 1, wherein the nitrogen-rich organic matter is one or more of melamine, dicyandiamide, and urea, preferably melamine and/or urea.

3. The method according to claim 1, wherein the metal salt is selected from one or more of ammonium molybdate, sodium tungstate, nickel acetate, potassium nitrate, zinc acetate, copper sulfate, cobalt nitrate, sodium vanadate, and ferrous sulfate, preferably one or more of ammonium molybdate, sodium tungstate, zinc acetate, copper sulfate and nickel acetate, and more preferably ammonium molybdate and/or zinc acetate.

4. The method according to claim 1, wherein in step (1), the mass ratio of the nitrogen-rich organic matter to the metal salt is 100:(1-50), preferably 100:(1-20), and more preferably 100:(3.2-10.4).

5. The method according to claim 1, wherein in step (2), the conditions of calcination comprise: holding at a temperature of 400-700° C. for 1-20 hours, and the heating rate thereof is 1-50° C./min.

6. The method according to claim 5, wherein the conditions of calcination comprise: holding at a temperature of 500-600° C. for 4-10 hours, and the heating rate thereof is 3-20° C./min.

7. The method according to claim 1, wherein in step (2), the calcination is carried out under the protection of an optional inert gas, and the inert gas is argon, nitrogen or helium.

8. The metal-doped amorphous carbon nitride photocatalytic material prepared by the method of 1.

9. The photocatalytic material according to claim 8, wherein the photocatalytic material contains a metal-doped amorphous carbon nitride structure; the metal is one or more of an alkali metal, an alkaline earth metal, and a transition metal; preferably, the metal is one or more of molybdenum, tungsten, nickel, potassium, zinc, copper, cobalt, vanadium and iron; more preferably, the metal is one or more of molybdenum, tungsten, nickel, zinc and copper; most preferably, the metal is molybdenum and/or zinc;
preferably, the photocatalytic material does not exhibit a diffraction peak at 10°-70° in the X-ray diffraction pattern.

10. The photocatalytic material according to claim 9, wherein the photocatalytic material has photocatalytic activity in the visible region of 450-800 nm.
